(19) United States
(12) Patent Application Publication
(10) Pub. No.: US 2017/0212940 A1
(43) Pub. Date: Jul. 27, 2017

(54) FILE SYSTEM FOR SUPPORTING TIME-SERIES ANALYSIS AND OPERATING METHOD THEREOF

(71) Applicant: ELECTRONICS AND TELECOMMUNICATIONS RESEARCH INSTITUTE, Daejeon (KR)

(72) Inventors: Ki Sung JIN, Daejeon (KR); Sang Min LEE, Daejeon (KR); Young Kyun KIM, Daejeon (KR)

(21) Appl. No.: 15/166,904

(22) Filed: May 27, 2016

(30) Foreign Application Priority Data
Jan. 21, 2016 (KR) 10-2016-0007570

(51) Int. Cl. G06F 17/30; G06F 11/14

(52) U.S. Cl. CPC G06F 17/30551; G06F 17/30106; G06F 17/30073; G06F 17/30079; G06F 11/1451; G06F 2201/835

(57) ABSTRACT

A file system for supporting a time-series analysis on data of a previous point in time and an operating method thereof. The file system includes a storage server configured to store input data, and provide data suitable for a data request among the stored data, and an analysis server configured to receive the data from the storage server according to an analysis request, and perform an analysis on the received data, and the storage server assigns a time-series attribute to data together with the data, and stores the time-series attribute together with the data.

### CROSS-REFERENCE TO RELATED APPLICATION

This application claims priority to and the benefit of Korean Patent Application No. 10-2016-0007570, filed on Jan. 21, 2016, the disclosure of which is incorporated herein by reference in its entirety.

### BACKGROUND

1. Field of the Invention

The present invention relates to a file system, and more particularly, to a file system for supporting a time-series analysis on data of a previous point in time and an operating method thereof.

2. Discussion of Related Art

With the development of information and communication technology, a large amount of data is being generated in real time in modern society due to accelerated digital innovation. Particularly, the appearance of various information channels such as a social service and a smart device, etc. and an increase of the amount of production, distribution, and holding of information have led to an explosive growth in data, and the increase is exceed a limitation of a conventional data management and analysis system.

Big data analysis is a representative service model for rapidly analyzing the upsurge in data. The representative examples of big data services are a social network service (SNS) analysis, a stock flow analysis, a user purchase pattern analysis, etc.

The services have a common feature of always performing an analysis on current data which is accumulated in the file system.

In some cases, it is important to recognize an information flow to a current point in time based on an analysis result on the data of a specific previous point in time, but the current big data service model does not provide the method.

The biggest reason why the current big data service model does not provide the analysis result on the data of a previous point in time is that a file system that manages data always preserves only data of a current point in time.

Accordingly, in order to perform the time-series analysis on the previous data in the current stage of technology, there is a method of previously copying and storing data of an estimated point in time to be analyzed, but the method has the following problems.

First, since the data of the point in time to be analyzed is previously copied and stored, inefficiency occurs. In particular, as the number of times of copying is increased or the amount of data to be copied is increased, it is difficult to avoid space inefficiency according to data duplication.

Next, since it is realistically difficult to previously estimate the point in time to be analyzed, there is a problem of copying and preserving the data of many more points in time for a precise analysis. As the number of times of preserving the data is increased, since the amount of data stored in duplicate is also increased, wasted space in the file system is increased in proportion to the number of times of preserving the data.

Next, although it is possible to only perform the analysis on the data of the specific point in time when the data corresponding to the specific point in time is preserved, it is not possible to perform an analysis on the data changed in an arbitrary time range. In particular, it is not possible to perform the analysis on the data changed in an arbitrary time range such as a “last week” or “last month” in the method.

### SUMMARY OF THE INVENTION

The present invention is directed to a file system for supporting a time-series analysis on data of a previous point in time, and an operating method thereof.

According to one aspect of the present invention, there is provided a file system for supporting a time-series analysis, including: a storage server configured to store input data, and provide data suitable for a data request among the stored data; and an analysis server configured to receive the data from the storage server according to an analysis request, and perform an analysis on the received data, wherein the storage server assigns a time-series attribute to data together with the data, and stores the time-series attribute together with the data.

According to another aspect of the present invention, there is provided an operating method of a file system for supporting a time-series analysis, including: storing input data by a storage server; requesting data from the storage server according to an analysis request, by an analysis server; providing the data to the analysis server according to the data request, by the storage server; and performing an analysis on the data provided from the storage server, by the analysis server, wherein the storing of the input data includes storing a time-series attribute for the data together with the data.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram illustrating a file system for supporting a time-series analysis according to an embodiment of the present invention;

FIG. 2 is a diagram for describing a type of a time-series analysis provided by a file system according to an embodiment of the present invention;

FIG. 3 is a flowchart illustrating a flow according to an operation of a file system according to an embodiment of the present invention;

FIG. 4 is a diagram illustrating an example of a data storage structure of a file system according to an embodiment of the present invention;

FIG. 5 is a diagram illustrating an example for describing an operation when changing data of a file system according to an embodiment of the present invention;

FIG. 6 is a flowchart illustrating a flow according to an operation of processing data of a file system according to an embodiment of the present invention;

FIG. 7 is a flowchart illustrating a flow according to an operation of providing current data of a file system; and

FIG. 8 is a flowchart illustrating a flow according to an operation of providing time-series data of a file system according to an embodiment of the present invention.

### DETAILED DESCRIPTION OF EXEMPLARY EMBODIMENTS

The above and other objects, features and advantages of the present invention will become more apparent with reference to embodiments which will be described hereinafter with reference to the accompanying drawings. However, the present invention is not limited to embodiments which will be described hereinafter, and can be implemented as various different types. The embodiments of the present invention are described below in sufficient detail to enable those of ordinary skill in the art to embody and practice the present invention. The present invention is defined by its claims. Throughout the specification, like reference numerals represent like components.

When it is determined that a detailed description of a well-known function or configuration related to the present invention can unnecessarily obscure the subject matter of the present invention, the description will be omitted. The terminology which will be described hereinafter is terminology defined by considering functions of embodiments of the present invention, and may be changed according to intention or custom, etc. of a user or operator. Accordingly, the terminology should be defined based on the content throughout the specification.

Hereinafter, a file system for supporting a time-series analysis according to an embodiment of the present invention and an operating method thereof will be described with reference to the accompanying drawings.

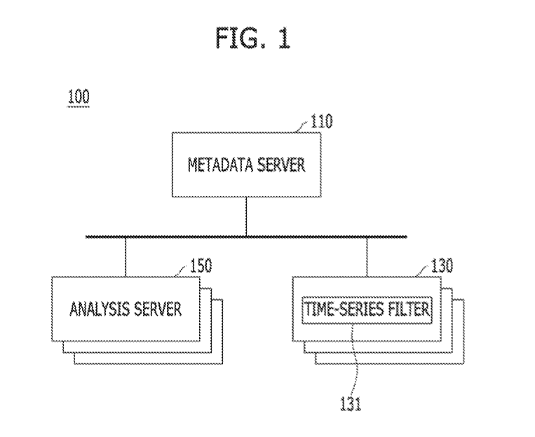

FIG. 1 is a block diagram illustrating a file system for supporting a time-series analysis according to an embodiment of the present invention.

Referring to FIG. 1, a file system for supporting a time-series analysis 100 (hereinafter, a “file system”) according to an embodiment of the present invention includes a metadata server 110, a storage server 130, and an analysis server 150.

The metadata server 110 integrates and manages metadata of the file system 100 and all resources configuring the file system 100.

The storage server 130 manages actual data of a file. In this case, due to characteristics of the file system for processing a large amount of data, the file system preferably includes a plurality of storage servers 130, and the plurality of storage servers 130 is connected via a network.

As the number of the storage servers 130 is increased, performance and capacity of the file system 100 is increased.

Meanwhile, the storage server 130 assigns a time-series attribute to each piece of data when storing data so that the file system 100 can support the time-series analysis, and stores the data together with the time-series attribute.

Here, the time-series attribute is a value assigned to each piece of data (file) included in the file system 100, and has a characteristic such as a sort of time stamp. Accordingly, it is possible to determine a time period of the data using a time attribute assigned to each piece of data.

An actual physical time, an arbitrary logical value, etc. may be used as the time-series attribute. However, the time-series attribute is assigned so that the value is always increased in a level of the file system 100.

Further, the storage server 130 includes a time-series filter 131, and the time-series filter 131 is included to extract and provide data suitable for a request when there is the request for the time-series analysis.

That is, the time-series filter 131 compares the time-series attribute assigned to each piece of data and a time-series attribute requested by a user, and performs a function of selecting only data satisfying a time-series condition of the user.

Accordingly, the storage server 130 is configured to provide every piece of data which is currently being stored, or provides data satisfying the condition among the stored data.

The analysis server 150 reads the data stored in the storage server 130, and performs an analysis operation on the data.

In this case, in order to access data stored in the storage server 130, the analysis server 150 may use a Java interface such as a Hadoop application program, or a portable operating system interface (POSIX) such as a conventional business analysis program, but a method of accessing the data is not limited thereto.

Meanwhile, the analysis server 150 may perform an analysis (a “current data analysis”) on every piece of data which is currently being stored in the storage server 130, and also perform an analysis (a “time-series data analysis”) on the data satisfying a specific condition among data stored in the storage server 130.

When the analysis server 150 performs the time-series data analysis, the analysis server 150 transmits the time-series condition together with the data request to the storage server 130.

In this case, the time-series condition may be a point query designating a specific time, or a range query designating an arbitrary time range.

That is, when the analysis server 150 provides the time-series condition together with the data request in order to perform the time-series analysis, the storage server 130 extracts the data satisfying the time-series condition, and provides the extracted data to the analysis server 150.

As one example, when the analysis type is the point query, a specific time-series value TWM-A is provided as the time-series condition, and the storage server 130 extracts the data having a time-series value smaller than the provided time-series value TWM-A, and provides the extracted data to the analysis server 150.

As another example, when the analysis type is the range query, time-series values TWM-B and TWM-C corresponding to the arbitrary time range are provided as the time-series condition, and the storage server 130 extracts the data having the time-series values corresponding to the provided time-series values TWM-B and TWM-C, and provides the extracted data to the analysis server 150.

Hereinbefore, the structure of the file system according to an embodiment of the present invention was described. Hereinafter, a type of the time-series analysis provided by the file system according to an embodiment of the present invention will be described in detail with reference to the accompanying drawings.

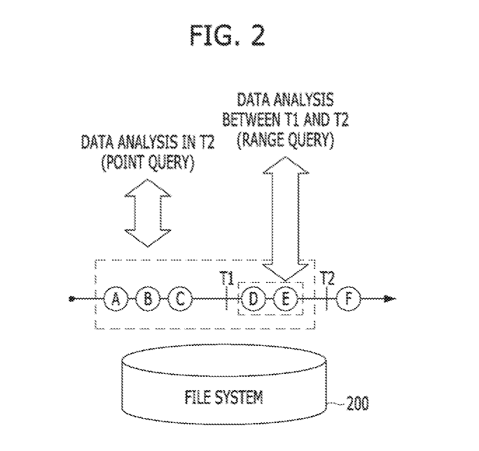

FIG. 2 is a diagram for describing a type of a time-series analysis provided by a file system according to an embodiment of the present invention.

Referring to FIG. 2, a file system 200 according to an embodiment of the present invention performs an analysis on data present in a specific time designated by a user (PONIT QUERY), or performs an analysis on data present in a specific time range set by the user (RANGE QUERY).

For convenience of explanation, as shown in FIG. 2, assume that data pieces A to C are generated before a time T1, data pieces D and E are generated in a time period between T1 and T2, and data piece F is generated after the time T2.

When using a current file system, only an analysis on every data piece A to F may be performed, but it is not possible to select and analyze data of a specific point in time.

However, when receiving the data analysis request of the time T2 from the user, the file system 200 according to an embodiment of the present invention performs the analysis on the data pieces A to E, and when receiving the data analysis request of the time period of T1 and T2 from the user, performs the analysis on the data pieces D and E.

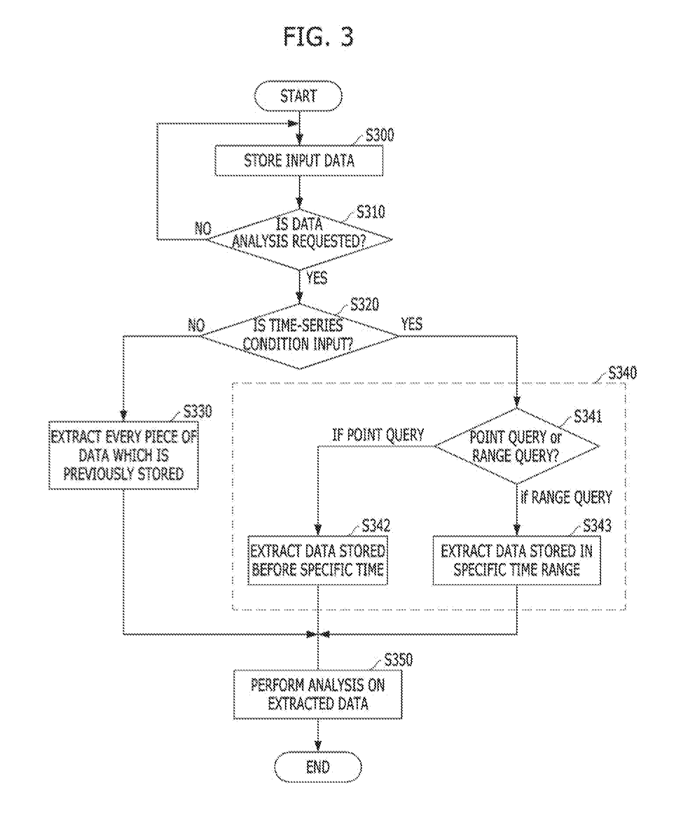

FIG. 3 is a flowchart illustrating a flow according to an operation of a file system according to an embodiment of the present invention.

Referring to FIG. 3, the file system 100 stores input data (S300), determines whether the data analysis request is input (S310), and when it is determined that the data analysis request is input (S310—Yes), performs the data analysis according to the request.

In detail, based on the determination result in the operation S310, when it is determined that the data analysis request is input (S310—Yes), the file system 100 determines whether the time-series condition is input together with the data analysis request (S320).

Based on the determination result in the operation S320, when it is determined that the time-series condition is not input (S320—No), the file system 100 extracts every piece of data which is previously stored in the storage server 130 (S330).

On the other hand, based on the determination result in the operation S320, when it is determined that the time-series condition is input (S320—Yes), the file system 100 extracts data satisfying the time-series condition among data which is previously stored in the storage server 130 (S340).

In detail, first, the file system 100 determines whether the time-series condition is the specific time or the specific time range (S341). That is, the file system 100 determines whether the time-series condition is the point query type or the range query type.

Based on the determination result in the operation S341, when the time-series condition is the specific time (the point query type), the file system 100 extracts data stored before the specific time (S342).

On the other hand, based on the determination result in the operation S340, when the time-series condition is the specific time range (the range query type), the file system 100 extracts data stored in the specific time range (S343).

Then, the analysis on the extracted data in the operation S330 or the extracted data in the operation S340 is performed (S350).

Hereinbefore, the file system for supporting the time-series analysis according to an embodiment of the present invention and the operating method thereof were described. Hereinafter, a data processing operation of the file system according to an embodiment of the present invention will be described in detail.

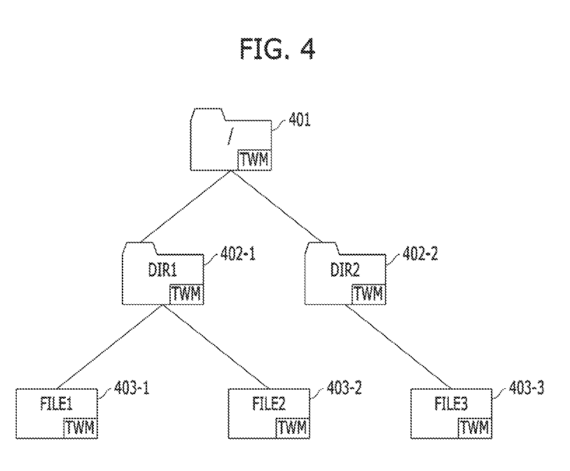

FIG. 4 is a diagram illustrating an example of a data storage structure of a file system according to an embodiment of the present invention.

The data storage structure shown in FIG. 4 is a case in which a time water mark (TWM) is applied as the time-series attribute, and the time-series attribute may be a real physical time, an arbitrary logical value, etc. in addition to the TWM.

Referring to FIG. 4, the data storage structure of the file system may be configured as a hierarchical structure having a tree form, a root directory 401 is the uppermost directory, and child directories 402-1 and 402-2 are subdirectories of the root directory 401.

Also, the hierarchy of the tree is determined by a parent-child relation of each directory, and subdirectories or subfiles 403-1, 403-2, and 403-3 may be present in every directory.

In this case, the TWM which is a specific time value is assigned to every directory or file in the file system, and each TWM refers to a time-series value when a corresponding directory or file is generated or changed.

Meanwhile, as described above, since the TWM referring to the time-series attribute has a characteristic of being always increased in a system level, the time in which each directory or file is generated or changed may be recognized using the time-series attribute.

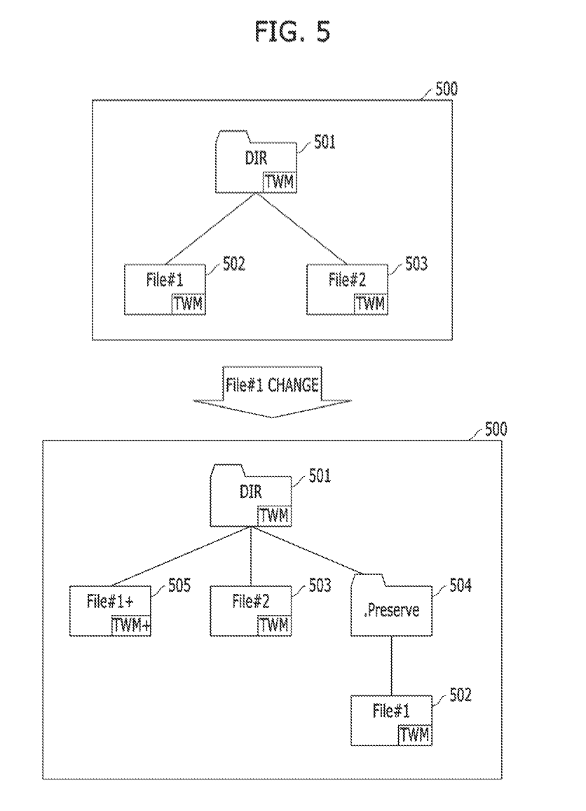

FIG. 5 is a diagram illustrating one example for describing an operation when changing data of a file system according to an embodiment of the present invention.

In order to describe an operation when changing data of the file system according to an embodiment of the present invention, as shown in FIG. 5, assume that a directory (DIR) 501 is the uppermost directory, File#1 502 and File#2 503 are subdirectories of the DIR 501, and the File#1 502 is changed.

In the conventional file system, when an update of a file is generated, since data of the File#1 502 is not preserved and a new File#1+ 505 is created by overwriting the data of the File#1 502 using new data, the time-series analysis on the File#1 502 may not be performed.

However, when a file system 500 according to an embodiment of the present invention updates the File#1 502, the file system 500 creates a new subdirectory .Preserve 504 in the parent DIR 501 of the File#1 502, stores the File#1 502 in the .Preserve 504, and after this, creates the File#1+ 505 by updating the File#1 502.

After the data processing described above is performed, when there is a request for current data, the file system 500 may provide the File#1+ 505 and the File#2 503.

Accordingly, no matter how many files are present in the .Preserve 504, performance of accessing the current data is not affected. Accordingly, even when using the file system according to an embodiment of the present invention, the analysis on only the most recent data may ensure the same performance as the current analysis regardless of the time-series attribute.

Further, after performing the data processing described above, when the File#1 502 which is a file before the File#1 502 is changed to the File#1+ 505 is requested according to the time-series condition, the file system 500 searches for the .Preserve 504, and may provide the File#1 502 satisfying the time-series condition.

As such, according to the data processing method of the file system according to the present invention, since both the file before being updated and the file after being updated are stored in the file system, the time-series analysis on the previous data as well as the current data may be performed using the file system according to the present invention.

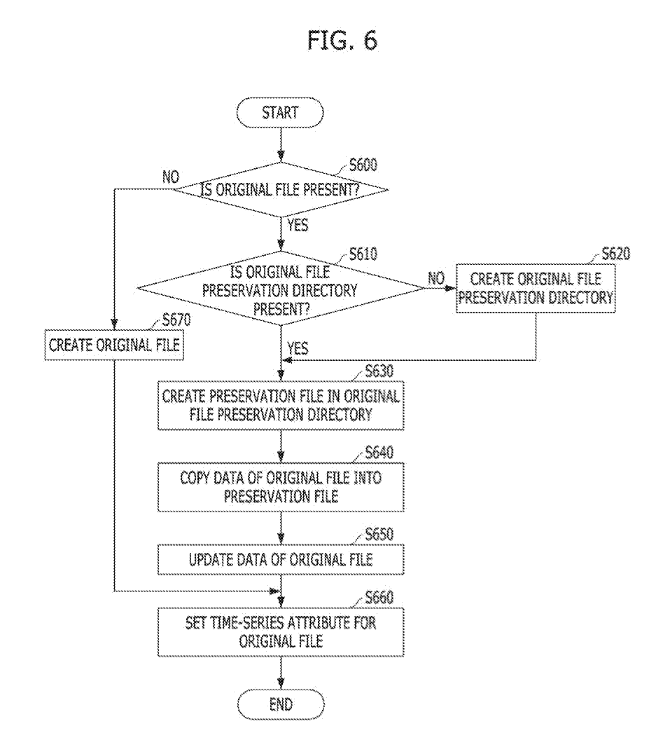

FIG. 6 is a flowchart illustrating a flow according to an operation of processing data of a file system according to an embodiment of the present invention.

An operation shown in FIG. 6 may be performed by the storage server 130 of the file system 100, and first, the storage server 130 determines whether a file (an “original file”) which is desired to be generated is currently present (S600).

Based on the determination result in the operation S600, when it is determined that the original file is present (S600—Yes), the storage server 130 determines whether a directory (an “original file preservation directory”) for preserving the original file is present (S610).

Based on the determination result in the operation S610, when it is determined that the original file preservation directory is not present (S610—No), the storage server 130 generates the original file preservation directory (S620), and generates a preservation file in the generated original file preservation directory (S630).

On the other hand, based on the determination result in the operation S610, when it is determined that the original file preservation directory is present (S610—Yes), the storage server 130 generates the preservation file in the original file preservation directory (S630).

After this, the storage server 130 copies data of the original file into the preservation file (S640), and after updating the data of the original file (S650), sets the time-series attribute for the original file (S660).

In this case, the storage server 130 copies the time-series attribute while copying the data of the original file into the preservation file, and the current time may be set as the time-series attribute.

On the other hand, based on the determination result in the operation S600, when it is determined that the original file is not present (S600—No), the storage server 130 sets the time-series attribute for the original file (S660) after creating the original file (S670).

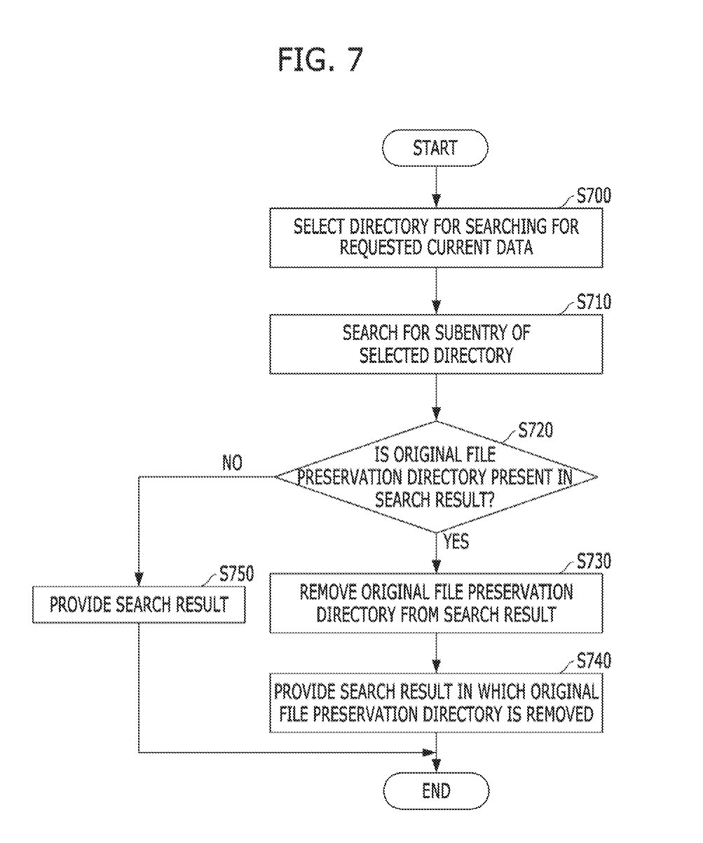

FIG. 7 is a flowchart illustrating a flow according to an operation of providing current data of a file system according to an embodiment of the present invention.

An operation shown in FIG. 7 may be performed by the storage server 130 of the file system 100, and when the storage server 130 receives a request for current data, the storage server 130 selects a directory for searching for the requested current data (S700), and searches for a subentry of the selected directory (S710).

After the search is performed according to the operation S710, whether the original file preservation directory is present in the search result is determined (S720).

Based on the determination result according to the operation S720, when it is determined that the original file preservation directory is present (S720—Yes), and the storage server 130 removes the original file preservation directory from the search result (S730), and provides the search result in which the original file preservation directory is removed (S740).

On the other hand, based on the determination result in the operation S720, when it is determined that the original file preservation directory is not present (S720—No), the storage server 130 provides the search result (S750).

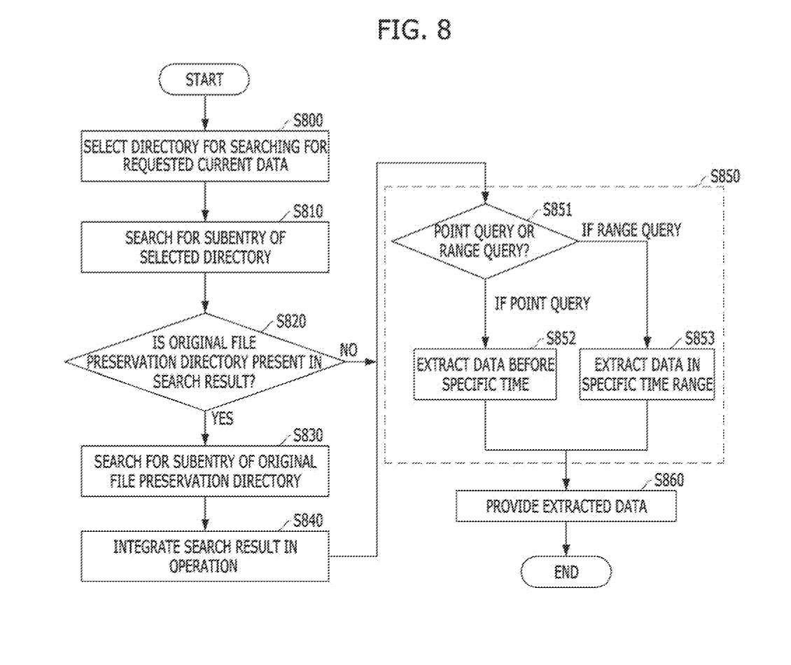

FIG. 8 is a flowchart illustrating a flow according to an operation of providing time-series data of a file system according to an embodiment of the present invention.

An operation shown in FIG. 8 may be performed by the storage server 130 of the file system 100, and when the storage server 130 receives a request for the time-series data, the storage server 130 selects a directory for searching for the requested time-series data (S800), and searches for a subentry of the selected directory (S810). The result found in the operation S810 is referred to as a first search result.

After the search is performed according to the operation S810, whether the original file preservation directory is present in the first search result is determined (S820).

In this case, based on the determination result according to the operation S820, when it is determined that the original file preservation directory is present (S820—Yes), the storage server 130 searches for a subentry of the original file preservation directory (S830). The result found in the operation S830 is referred to as a second search result.

Then, the storage server 130 integrates the first search result found in the operation S810 and the second search result found in the operation S830 (S840). The search result obtained by integrating the first search result and the second search result may be referred to as an integrated search result.

After the operation S840, the storage server 130 extracts data satisfying the time-series condition from the integrated search result (S850), and provides the extracted data (S860).

In this case, the operation of extracting the data satisfying the time-series condition from the search result according to the operation S850 may be performed by determining whether the time-series condition is the specific time (the point query type) or the specific time range (the range query type) (S851), extracting data before the specific time when the time-series condition is the specific time (S852), and extracting data in the specific time range when the time-series condition is the specific time range (S853).

On the other hand, based on the determination result according to the operation S820, when it is determined that the original file preservation directory is not present in the first search result (S820—No), the storage server 130 extracts the data satisfying the time-series condition from the first search result (S850), and provides the extracted data (S860).

The file system for supporting the time-series analysis and the operating method thereof according to the present invention are described according to the above-described embodiments, but the scope of the present invention is not limited to the above-described embodiments, and it should be apparent to those skilled in the art that various alternatives, modifications, and changes can be made to the above-described embodiments of the present invention without departing from the spirit or the scope of the invention.

According to the present invention, big data can be analyzed by accessing data of a time that the user wants by combining a time concept into each piece of data in the file system level.

Accordingly, according to the present invention, even when the data of a point in time which is desired to be analyzed is not preserved separately and previously, the big data can be analyzed by accessing data of the point in time that the user wants.

Further, according to the present invention, the time-series analysis in two forms of the analysis method for the data of the arbitrary point in time and the analysis method for the data changed in the arbitrary time range can be performed simultaneously.

The above-described embodiments and the accompanying drawings of the present invention are not intended to limit the scope of the invention but to describe the invention in all aspects. The scope of the present invention should be defined by the appended claims, and it is intended that the present invention covers all such modifications provided they come within the scope of the appended claims and their equivalents.

What is claimed is:

1. A file system for supporting a time-series analysis, comprising:
a storage server configured to store input data, and provide data suitable for a data request among the stored data; and
an analysis server configured to receive the data from the storage server according to an analysis request, and perform an analysis on the received data,
wherein the storage server assigns a time-series attribute to data together with the data, and stores the time-series attribute together with the data.

2. The file system for supporting the time-series analysis of claim 1, wherein, when a file (an “original file”) for storing data is present, the storage server creates a preservation file corresponding to the original file in an original file preservation directory, copies data of the original file into the preservation file, and updates the data of the original file.

3. The file system for supporting the time-series analysis of claim 2, wherein the storage server copies the time-series attribute while copying the data of the original file into the preservation file, and sets the time-series attribute while updating the data of the original file.

4. The file system for supporting the time-series analysis of claim 2, wherein the storage server provides current data or data satisfying a time-series condition according to a data request.

5. The file system for supporting the time-series analysis of claim 4, wherein, when a request for the current data is received, the storage server searches for a subentry of a directory selected for a search, and when the original file preservation directory is present in the search result, provides data after removing the original file preservation directory from the search result.

6. The file system for supporting the time-series analysis of claim 5, wherein, when the original file preservation directory is not present in the search result, the storage server provides the search result.

7. The file system for supporting the time-series analysis of claim 4, wherein, when a request for time-series data is received, the storage server generates a first search result by searching for a subentry of a directory selected for a search, and when the original file preservation directory is present in the first search result, the storage server generates a second search result by searching for a subentry of the original file preservation directory, generates an integrated search result by integrating the first search result and the second search result, and provides data satisfying the time-series condition in the generated integrated search result.

8. The file system for supporting the time-series analysis of claim 7, wherein, when the original file preservation directory is not present in the first search result, the storage server provides data satisfying the time-series condition in the first search result.

9. The file system for supporting the time-series analysis of claim 4, wherein the storage server provides the data according to a result obtained by determining whether the time-series condition is a specific time or a specific time range.

10. The file system for supporting the time-series analysis of claim 9, wherein, when the time-series condition is the specific time, the storage server provides data before the specific time, and when the time-series condition is the specific time range, provides data in the specific time range.

11. An operating method of a file system for supporting a time-series analysis, comprising:
storing input data by a storage server;
requesting data from the storage server according to an analysis request, by an analysis server;
providing the data to the analysis server according to the data request, by the storage server; and
performing an analysis on the data provided from the storage server, by the analysis server,
wherein the storing of the input data includes storing a time-series attribute for the data together with the data.

12. The operating method of the file system for supporting the time-series analysis of claim 11, wherein, when a file (an “original file”) for storing data is present, the storing of the input data includes creating a preservation file corresponding to the original file in an original file preservation directory, copying data of the original file into the preservation file, and updating the data of the original file.

13. The operating method of the file system for supporting the time-series analysis of claim 12, wherein the storing of the input data includes copying the time-series attribute while copying the data of the original file into the preservation file, and setting the time-series attribute while updating the data of the original file.

14. The operating method of the file system for supporting the time-series analysis of claim 12, wherein the providing of the data to the analysis server includes providing current data or data satisfying a time-series condition according to the data request.

15. The operating method of the file system for supporting the time-series analysis of claim 14, wherein, when a request for the current data is received, the providing of the data to the analysis server includes searching for a subentry of a directory selected for a search, and when the original file preservation directory is present in the search result, providing data after removing the original file preservation directory from the search result.

16. The operating method of the file system for supporting the time-series analysis of claim 15, wherein, when the original file preservation directory is not present in the search result, the providing of the data to the analysis server includes providing the search result.

17. The operating method of the file system for supporting the time-series analysis of claim 14, wherein, when a request for time-series data is received, the providing of the data to the analysis server includes generating a first search result by searching for a subentry of a directory selected for a search, and when the original file preservation directory is present in the first search result, the providing of the data to the analysis server includes generating a second search result by searching for a subentry of the original file preservation directory, generating an integrated search result by integrating the first search result and the second search result, and providing data satisfying the time-series condition in the integrated search result.

18. The operating method of the file system for supporting the time-series analysis of claim 17, wherein, when the original file preservation directory is not present in the first search result, the providing of the data to the analysis server includes providing data satisfying the time-series condition in the first search result.

19. The operating method of the file system for supporting the time-series analysis of claim 14, wherein the providing of the data to the analysis server includes providing the data according to a result obtained by determining whether the time-series condition is a specific time or a specific time range.

20. The operating method of the file system for supporting the time-series analysis of claim 19, wherein, when the time-series condition is the specific time, the providing of the data to the analysis server includes providing data before the specific time, and when the time-series condition is the specific time range, providing data in the specific time range.
